(19) United States
(12) Patent Application Publication
(10) Pub. No.: US 2010/0308642 A1
(43) Pub. Date: Dec. 9, 2010

(54) WHEEL

(76) Inventor: Gregor Bizjak, Smarje Pri Jelsah (SI)

Correspondence Address: SMITH MOORE LEATHERWOOD LLP, P.O. BOX 21927, GREENSBORO, NC, 27420, US

(21) Appl. No.: 12/863,918

(22) PCT Filed: Dec. 29, 2008
(86) PCT No.: PCT/SI2008/000069

§ 371 Date: Jul. 21, 2010

(30) Foreign Application Priority Data
Jan. 21, 2008 (SI) P-200800012

(51) Int. Cl. B60B 1/12; B60B 5/02

(52) U.S. Cl. 301/66

(57) ABSTRACT

A wheel adapted for use with high performance vehicles, such as for example, a high performance motorcycle, having, without limitation, one or more of the following characteristics: a low weight, low moment of inertia, reduced air resistance, ventilation capabilities, wheel variations tolerance, tyre pressure variation tolerance, thermal variation tolerance and/or impacts tolerance is disclosed.

The invention refers to a highly resistant vehicle wheel, in particular for motorcycles, airplanes or the like, and in particular to a wheel of a racing motorcycle, which is during the use exposed to extreme stresses and which during the regular use has to fulfill still further conditions, which are discussed in a further description.

Such an invention belongs to the field of transport and more precisely to vehicles or their parts, and concretely to wheels and vehicle rims or hubs, which are rotationally set on a corresponding axle. At the same time, the invention may also belong to wheels or rims, consisting of synthetic materials.

Accordingly, the purpose of the invention is to create such a wheel which should be sufficiently rigid in all directions for the purpose of use e.g. in the field of high performance motorcycles, and which should moreover excel in a relatively low weight and inertia moment when bearing in mind all anticipated extreme loadings, and by means of which moreover also several other undesired effects could be essentially reduced, in particular the air resistance due to ventilating the air in the adjacency of the wheel, and pressure variations within the tyre due to thermal and other impacts, to which such wheel is exposed.

In a most simplified version, such vehicle wheel consists of a hub as well as of adequate rim, which is interconnected with said hub via corresponding spokes, radial stabs or ribs or optionally via a compact circular wall being either straight or curved in profile. Such a possibility is for example described in DE 10 2004 027 566 A and refers to mounting a tyre on the wheel rim, and is here mentioned exclusively for the illustrative purposes. The wheel rim is normally formed as a ring having a radial cross-section adapted to receive a corresponding tire, either with inserted tube or available as a tubeless one, and is moreover adapted to be connected with each corresponding member or assembly, by means of which said rim is then connected with the belonging hub. However, extreme sharing or bending stresses may occur between said rim and connecting member within particular intervals of braking or accelerating, or also by suddenly changing a driving direction or as a consequence of impacts involved by configuration of terrain. Adjusting each dimensions of such wheel to said extreme stresses normally results in essential increasing of the weight and also of the moment of inertia. Such increasing of weight then normally leads to negative effects, and may results in proportionally increasing of fuel consumption and modification of bumpers together with each belonging components, which then by braking or accelerating of such increased mass unavoidable results in still further increasing of stresses. When the weight is spread along some higher diameter i.e. arranged at a greater distance apart from the hub i.e. from the centre of rotation, then the moment of inertia is higher, which normally results in two negative consequences. The first one refers to increasing of inertia, which results in essentially increased energy consumption by braking and accelerating. The second one is known to those skilled in the art as a so-called gyroscopic effect, which means that due to rotation of wheels having certain weight, at a high velocity the motorcycle persists in each particular direction and withstands to each change of a driving direction, so that guiding performances in the sense of quickly changing the driving direction of such motorcycle may be essentially hindered. Besides, a still further effect should be born in mind, which occurs due to extreme loadings by sufficiently high velocities. A tyre is placed on a circumferentially closed surface, which is furnished with a passage for mounting a valve of a corresponding tube or tubeless tyre, so that the volume of air within said tyre is relatively small. When rolled along the uneven terrain, the tyre is permanently deformed and each local variation of the pressure therein results in essential oscillations of pressure, despite to permanent dampening. Each impact and each oscillation results in certain impact on deforming the tyre and adhesion thereof towards the roadway, which is of extremely importance when driving along curvatures with relatively small radius. Consequently it is desired to ensure as much as possible volume of gas within the tyre, since the influence of the oscillations and related problems may herewith be essentially reduced. In the practice, the user may decide to use some larger or thicker tyre, which however results in increasing the weight and the moment of inertia of the wheel, and consequently, also in increasing the weight of the whole motorcycle.

Wheels as described in DE 10 2004 027 566 A, were earlier manufactured of steel, but upon that various light metals or alloys thereof became preferred due to possibility of reducing the weight and the moment of inertia as well as due to avoiding of corrosion or simply due to much more attractive aesthetic appearance. Due to manufacturing processes such wheels are normally cast, and comprise an hub and a rim, which are mutually interconnected via radial posts or spokes. Such wheel is described in DE 102004013489 A1. When anticipated that the stiffness of the wheel should remain practically the same, despite to essentially reduced specific weight in comparison with those consisting of steel, the volume of material is essentially greater than the volume of material in a steel wheel, and in addition to that, concentration of material in locations apart from the centre of rotation is increased. Consequently, despite to reduced weight of the wheels consisting of light metal, the moment of inertia may still remain at a relatively high level.

In order to avoid such deficiencies, DE 199 16 444 C2 has proposed a wheel consisting of two parts, which are assembled in a level perpendicular with respect to the rotation axis. Consequently, the spokes can be hollow, and the weight of the wheel is herewith reduced without essentially reducing stiffness and in addition, also the moment of inertia is reduced. Despite to such measures, just presence of the spokes leads to undesired increasing of ventilation and air-resistance, which is essentially expressed at some higher velocity. In addition, the rim is still a closed ring, so that the volume of gas within the tyre still remains quite low.

Furthermore, EP 0 539 214 B1 oz. DE 692 07 341 T2 has proposed a wheel consisting of a hub and a rim, which is via specifically designed spokes interconnected with said hub. Said wheel merely consists of fiber-reinforced composite materials. The hub is adapted to be mounted onto appropriate shaft or axle and is furnished with a plurality of threaded bores, which extend in the axial direction of the wheel. Said bores are intended for screwing the spokes, which are intended for bearing the rim. In general, three pairs of spokes are foreseen, wherein the spokes in each pair are bent into shape of the letter U and also the shape of their cross-section corresponds to the letter U, and form an oval, by which the rim and the hub are interconnected via a third of the wheel circumference. A cover is placed above said spokes in the form of three-stroke star, which is on the one hand attached to said spokes and on the other hand screwed to said bores on the hub. Still further, a rim is placed around the circumference of the wheel, which is adapted to cooperate with said spokes and the belonging cover and is intended to receive a tyre. Such wheel may also be manufactured on the basis of composite materials, since the spokes enable establishing of acceptable loading conditions, where the sharing forces and stresses in the critical zones are substituted by tensioning forces and stresses. Despite to that, manufacturing and also the use thereof may lead to several serious deficiencies. Due to numerous parts, which are mutually interconnected, such manufacturing is extremely comprehensive, which involves pretty high risks when bearing in mind expected accuracy and reliability. On the other hand, bearing members in certain zones of the wheel are doubled, which has no essential impact to in creasing of bearing capability, but may essentially increase the weight and the moment of inertia. Still further, the radial spokes may essentially contribute to increasing of ventilation and air-resistance, and moreover, the wheel rim is still a classic one, so that the volume of gas within the tyre is relatively small and essentially corresponds to volume, which is normally present in commonly used motorbikes.

Still further, a wheel is known from the commercial sources (e.g. www.blackstonetek.com or http://pages.ebay.at) which is manufactured by Blackstone TEK, 29 Northriding 2164, South Africa (ZA), wherein such wheel consists of a rim, which comprises two seats, which are arranged on its outer surface apart from each other and are adapted to receive a tyre, and wherein the rim is via spokes interconnected with the hub, which is arranged concentric with respect to the wheel rotation axis. Said rim, spokes and hub are integrally manufactured and consist of composite materials, reinforced by carbon fibers. A flange consisting of aluminium is attached to the hub e.g. by means of screwing or riveting, which is intended to transfer the moment in each desired direction, namely either during acceleration from the driving means towards the wheel, or during braking from the wheel towards the brake system. According to actual information, five strokes are foreseen, which however do not extend from the hub toward the rim in the radial direction but tangentially from the circumferential surface of the hub. Such concept results in a quite strange appearance, and moreover, due to presence of spokes and corresponding gaps there-between, the air is circulating intensively in the area of the wheel, which results in relatively high air-resistance and losses due said ventilation. Said spokes are compact ones, and their mass is therefore increasing the moment of inertia of the wheel. Of such reason the cross-section of the spokes is gradually reduced in a direction from the hub towards the rim. As a consequence, all forces are transferred from the hub towards the rim or vice versa via just five relatively small local zones, in which the spokes are interconnected with the radially inner surface of the rim, and these zones are then exposed to extreme stresses. In addition to that, the volume of air within the tyre still remains relatively small.

Besides, SI 22159 A (P-200500361) describes a wheel of a motorcycle, which generally consists of a hub and comprises two seats arranged on the circumferential surface of the wheel and are adapted to receive a tyre. Such wheel further comprises two concave and coaxial shells, which are faced oppositely apart from each other and are integrally interconnected with the hub, while between them also radial ribs are foreseen and are also integrally interconnected therewith. Each shell is then bearing a single seat for resting a tyre. Thanks to such concept of the wheel, the weight and the moment of inertia of such wheel are relatively low in spite of the capability to withstand the extreme stresses during the use with a racing motorbike, but at the same time several other undesired features are essentially reduced, for example the air-resistance due to ventilation of the air in the area of the wheel and also pressure variations, which otherwise occurs permanently due to varying of condition during the drive. Despite to aforementioned benefits, such concept may lead to certain problems, which are merely related to ensuring a sufficient rigidity during the step of introducing the air into the tyre. Such wheels are namely intended to be furnished with high-pressure tires, and which then allow some variation of gas pressure during the use within certain range. However, by filling the tyre with the air or any other gaseous mixture in the practice, the pressure is essentially increased within a short time period, so that the stresses on the wheel could increase above the pre-determined and still acceptable critical value. Of that reason, such a concept of the wheel requires handling with extreme attention and care, and is therefore much too risky to be commonly used from the side of a wide range of users.

U.S. Pat. No. 3,656,531 discloses a highly resistant wheel, comprising a hub, which is arranged symmetrically with respect to the wheel rotation axis and consists of a central shell and moreover of a wheel rim, which is also arranged symmetrically with respect to the wheel rotation axis and is firmly interconnected with said hub and furnished with appropriate ribs and seats arranged there-between and apart from each other in order to receive adequate tyre placed thereon. The rim and the central shell are mutually interconnected by means of a desired number of radially extending tubular spokes, which are arranged equidistantly apart from each other in the circumferential direction, and each of them is firmly and gas-tightly attached to the central shell of the hub and outwardly open in the area of the rim.

The present invention refers to a highly resistant vehicle wheel, which comprises a hub arranged symmetrically with respect to the wheel rotation axis and consisting at least of a central shell and optionally also of a sleeve, which is furnished with appropriate flanges adapted to establish appropriate interconnection between said hub and corresponding parts of brake system and driving system, said wheel further comprising a wheel rim, which is also arranged symmetrically with respect to the wheel rotation axis and is firmly interconnected with said hub and furnished with appropriate ribs and seats arranged there-between and apart from each other in order to receive adequate tyre placed thereon. Said rim and said central shell are mutually interconnected by means of a desired number of radially extending tubular spokes, which are arranged equidistantly apart from each other in the circumferential direction, and each of them is firmly and gas-tightly attached to the central shell of the hub and outwardly open in the area of the rim.

According to the invention, each particular spoke is firmly and gas-tightly interconnected with two neighboring spokes in the area of contact lines, which are arranged on the inner portion thereof adjacent to the hub and converge towards said hub, wherein on the radially outer portion thereof it is outwardly open in the radial direction, and wherein a closed box-like chamber is available in area adjacent to said radially outer area and therefore in the area of each corresponding wedge-shaped gap between each particular spoke and each neighboring spoke adjacent to the rim. Said chamber is preferably filled with a foamed material. The central shell of the hub, the wheel rim and said spokes form an integral assembly and are manufactured simultaneously and moreover consist of the same material. In one of the embodiments, said central shell of the hub, which is adapted to receive a sleeve, and moreover said rim and said spokes consist of material on the basis of composites reinforced by carbon fibers. In this, said central shell is adapted to receive the sleeve, which is adapted to be interconnected with at least one flange, which is intended to cooperate with corresponding parts of a brake system and/or driving transmission means of the vehicle, and is either in a detachable manner, preferably via appropriate screw members, or firmly i.e. in a non-detachable manner, for example by means of adhesive or by riveting or when desired also by screwing. Still further, in the sense of the invention each of said spokes is conceived in such a manner at least in its outer area has a flattened circular or at least approximately oval or elliptic cross-section, wherein the width if the cavity of each particular spoke on the open end portion thereof adjacent to the rim corresponds to 20-75% of a total width of the wheel rim between the ribs, and preferably to 30-50% of said total width, while the length of the cavity of the spoke within the same area in the circumferential direction of the wheel is greater than said width of the cavity of the spoke and is 1.1 to 2-times greater than said width, and preferably 1.2 to 1.5-times greater than said width. The number of spokes corresponds to 5-15, preferably 6-12 and most preferably 8-10.

Now the invention will be explained in more detail on the basis of two embodiments, which are presented in the enclosed drawings, where

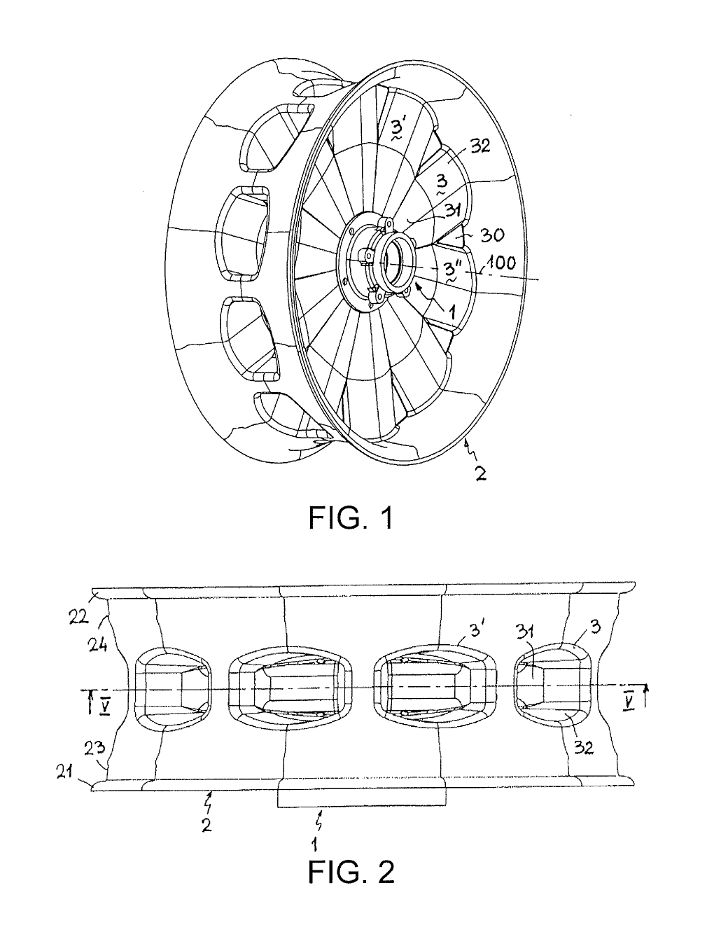

FIG. 1 is a perspective view of the first embodiment of a wheel according to the invention, namely a rear wheel of a racing motorcycle without a tyre;

FIG. 2 is a plan view of a wheel according to FIG. 1;

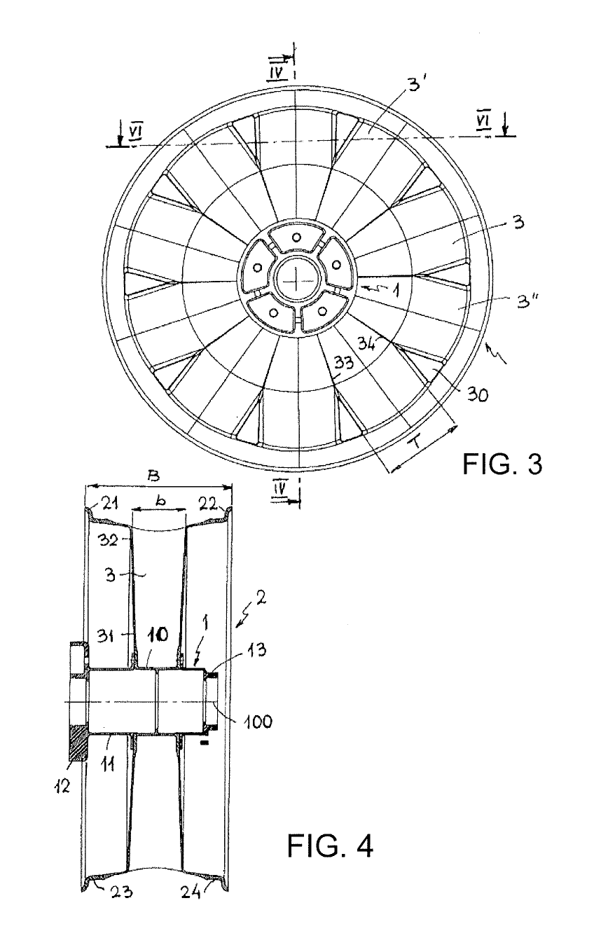

FIG. 3 is a front view of a wheel according to FIGS. 1 and 2;

FIG. 4 is a cross-section along the plane IV-IV according to FIG. 3;

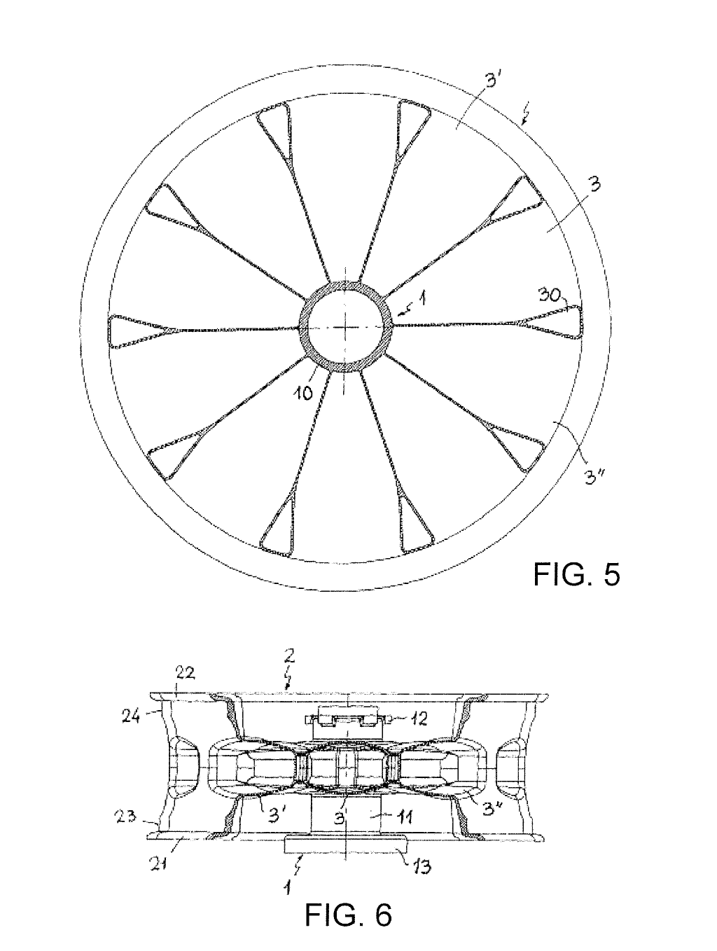

FIG. 5 is a cross-section along the plane V-V according to FIG. 2;

FIG. 6 is a cross-section along the plane VI-VI according to FIG. 3;

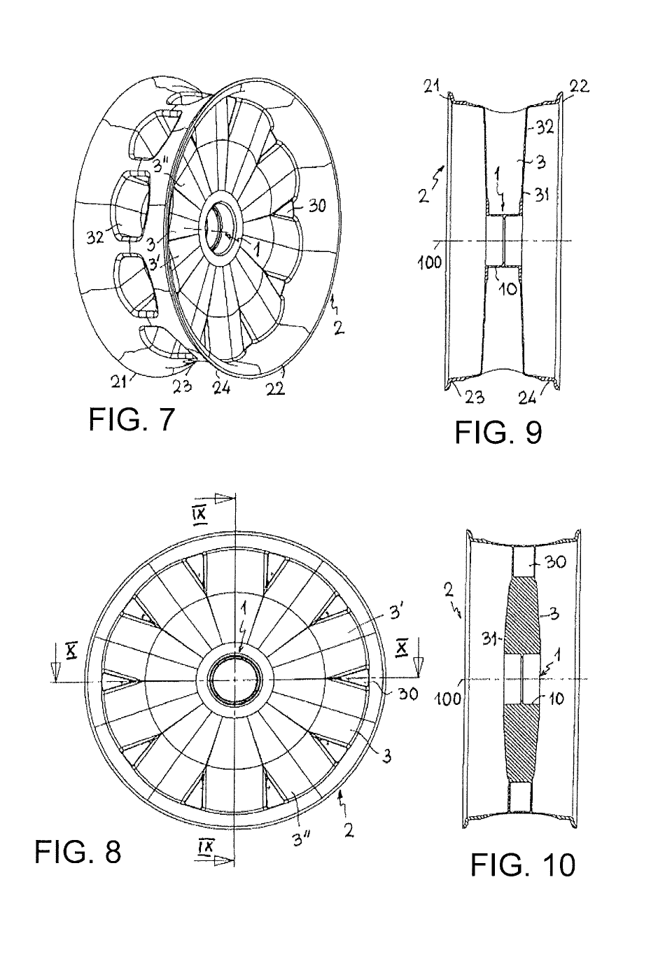

FIG. 7 is a perspective view of a further embodiment of a wheel according to the invention, namely a front wheel of a racing motorcycle without a tyre;

FIG. 8 is a front view of a wheel according to FIG. 7;

FIG. 9 is a cross-section along the plane IX-IX according to FIG. 8; and

FIG. 10 is a cross-section along the plane X-X according to FIG. 8.

A wheel according to the invention consists of a hub 1, which is arranged symmetrically with respect to a wheel rotation axis 100 and is at appropriate radial distance surrounded by a wheel rim 2, which is also arranged symmetrically with respect to a wheel rotation axis 100, and moreover, a group of equidistantly apart from each other arranged tubular spokes 3, 3′, 3″ is foreseen between said rim 2 and said hub 1, by means of which the rim 2 and the hub 1 are firmly connected to each other.

Each of these spokes 3, 3′, 3″ is formed as a tube, and is preferably flattened in the transversal direction of the wheel i.e. along the wheel rotation axis 100. The spokes 3, 3′, 3″ are formed integrally with the rim 2 and with the central shell 10 of the hub 1, and preferably consist of a composite material reinforced with carbon fibers. Besides, each spoke 3, 3′, 3″ is open radially outwards and in a gas-tightly manner closed and firmly interconnected with the central shell 10 of the hub 1. Consequently, each spoke 3, 3′, 3″ has preferably oval or elliptic cross-section.

Each spoke 3 is furthermore in the inner area 31 close to the hub 1 firmly and gas-tightly interconnected with two adjacent spokes 3′, 3″, while in its outer area 32 there is a gap in form of wedge-shaped and radially inwards converging chamber 30 (FIGS. 5 and 10), which is preferably filled with a light foamed substance and is characterized by a relatively small thickness, at least when compared with the width or thickness b of the spoke 3, 3′, 3″.

Each spoke 3 is in its inner area 31 firmly and gas-tightly interconnected with each neighboring spokes 3′, 3″ along the contact lines 33, 34, which converge radially inwards and towards the hub 1.

As already mentioned, the hub 1 comprises a central shell 10, to which a sleeve 11 is attached via appropriate screw members 15 and which includes at least a flange 12 adapted to receive a bearing together with a brake disc (not shown) as well as a flange or a seat 13 adapted to receive a bearing together with a driving means, e.g. a chain wheel, a gear or the like.

The rim 2 is furnished with appropriate ribs 21, 22, which are arranged apart from each other on the outer circumferential surface 20 and in adjacency of which adequate seats 23, 24 are foreseen, on which a tyre (not shown) is then rest.

Thanks to such concept, a wheel is therefore realized, in which a corresponding assembly of components, namely outwardly open spokes 3, 3′, 3″ together with accompanying chambers 30, which are mutually interconnected in the area of contact lines 33, 34 and on the one hand attached to the wheel rim 2 and on the other hand to the central shell 10 of the hub 1, results in extreme rigidity of the wheel in all directions despite to extremely low weight and moment of inertia around the central rotation axis 100. In addition to that, all commonly present passages and recesses between each neighboring spokes 3, 3′, 3″ are eliminated and even the gaps between the spokes 3, 3′, 3″ are transformed into closed chambers 30, and consequently the ventilating effect even by extremely high velocities of turning the wheel around the axis 100 is then extremely low and is practically minimized to negligible values.

In particular, excellent characteristics of the wheel according to the invention in the context of rigidity and ventilation may be achieved when the width b of the cavity of each spoke 3, 3′, 3″ in the area of the open end portion 32 closely to the wheel rim 2 between said rims 21, 22 is adjusted to 20 to 75% and preferably between 30 and 50% of the width B of the rim 2. In this, the length T of the cavity of each spoke 3, 3′, 3″ in the circumferential direction of the wheel is between greater than the width b of the cavity of each spoke 3, 3′, 3″, namely at least for 1.1- to 1.2-times greater than the width b and is preferably between 1.3 to 1.5 times greater than the width b.

When a tyre, which is not shown in the drawing, is mounded on the rim 2 of the wheel according to the invention, said tyre is rest on the outer surface 20 of the rim 2 in the same manner like in any other commonly known wheels. However, when the tyre is then filled with the air or any other gaseous mixture, then like in commonly known wheels a certain portion of gas is stored within the tyre, but in addition to that, an essential volume of gas is also stored within the spokes 3, 3′, 3″ i.e. practically within the complete area between the central shell 10 and the rim 20, except in said chambers 30. Such a disposable volume of gas is then able to compensate possible variations of the gas pressure during the use, which may occur due to either varying the temperature or the shape of the tyre by driving, by which the adhesion of the wheel towards the ground in various situations is then essentially improved. At the same time, essentially reduced weight of the wheel results in essential contribution in the sense of reduction the gyroscopic effect, which results in essentially improved guidance of the vehicle each desired direction.

1. Highly resistant vehicle wheel, comprising a hub (1), which is arranged symmetrically with respect to the wheel rotation axis (100) and consists at least of a central shell (10) and optionally also of a sleeve (11), which is furnished with flanges (12, 23) adapted to establish appropriate interconnection between said hub (1) and corresponding parts of brake system and driving system, and moreover of a wheel rim (2), which is also arranged symmetrically with respect to the wheel rotation axis (100) and is firmly interconnected with said hub (1) and furnished with appropriate ribs (21, 22) and seats (23, 24) arranged there-between and apart from each other in order to receive adequate tyre placed thereon, characterized in that said rim (2) and said central shell (10) are mutually interconnected by means of a desired number of radially extending tubular spokes (3, 3′, 3″), which are arranged equidistantly apart from each other in the circumferential direction, and each of them is firmly and gas-tightly attached to the central shell (10) of the hub (1) and outwardly open in the area of the rim (2).

2. Wheel according to claim 1, characterized in that each particular spoke (3) is firmly and gas-tightly interconnected with two neighboring spokes (3′, 3″) in the area of contact lines (33, 34), which are arranged on the inner portion (31) thereof adjacent to the hub (1) and converge towards said hub (1), while on the radially outer portion (32) thereof it is outwardly open in the radial direction, wherein a closed box-like chamber (30) is available in area adjacent to said radially outer area (32) and therefore in the area of each corresponding wedge-shaped gap between each particular spoke (3) and each neighboring spoke (3′, 3″) adjacent to the rim (2).

3. Wheel according to claim 1 or 2, characterized in that the central shell (10) of the hub (1), the wheel rim (2) and said spokes (3, 3′, 3″) form an integral assembly and are manufactured simultaneously and consist of the same material.

4. Wheel according to claim 3, characterized in that said central shell (10) of the hub (1), which is adapted to receive a sleeve (11), and moreover said rim (2) and said spokes (3, 3′, 3″) consist of material, which is a material on the basis of composites reinforced by carbon fibers.

5. Wheel according to anyone of the preceding claims, characterized in that said central shell (10) is adapted to receive the sleeve (11), which is adapted to be interconnected with at least one flange (12, 13), which is intended to cooperate with corresponding parts of a brake system and/or driving transmission means of the vehicle.

6. Wheel according to claim 5, characterized in that said sleeve (11), which is interconnected with at least one flange (12, 13) adapted to cooperate with corresponding parts of a brake system and/or driving transmission means of the vehicle, is in a detachable manner interconnected with said central shell (10) of the hub (1).

7. Wheel according to claim 6, characterized in that said sleeve (11) is interconnected with said central shell (10) of the hub (1) by means of screw members (15).

8. Wheel according to claim 5, characterized in that said sleeve (11), which is interconnected with at least one flange (12, 13) adapted to cooperate with corresponding parts of a brake system and/or driving transmission means of the vehicle, is firmly i.e. in a non-detachable manner interconnected with said central shell (10) of the hub (1).

9. Wheel according to claim 8, characterized in that said sleeve (11) is interconnected with said central shell (10) of the hub (1) by means of adhesion.

10. Wheel according to claim 8, characterized in that said sleeve (11) is interconnected with said central shell (10) of the hub (1) by means of riveting.

11. Wheel according to claim 8, characterized in that said sleeve (11) is interconnected with said central shell (10) of the hub (1) by means of adhesion and riveting.

12. Wheel according to claim 8, characterized in that said sleeve (11) is interconnected with said central shell (10) of the hub (1) by means of adhesion and screwing.

13. Wheel according to anyone of claims 5-12, characterized in that said sleeve (11) consists of a metallic material.

14. Wheel according to claim 6, characterized in that each chamber (30) is filled with the light foamed material.

15. Wheel according to anyone of claims 1-14, characterized in that each of said spokes (3, 3′, 3″) at least in its outer area has a flattened circular or at least approximately oval or elliptic cross-section, wherein the width (b) if the cavity of each particular spoke (3, 3′, 3″) on the open end portion (32) thereof adjacent to the rim (2) corresponds to 20-75% of a total width (B) of the wheel rim (2) between the ribs (21, 22), and preferably to 30-50% of said total width (B), while the length (T) of the cavity of the spoke (3, 3′, 3″) within the same area (32) in the circumferential direction of the wheel is greater than said width (b) of the cavity of the spoke (3, 3′, 3″) and is 1.1 to 2-times greater than said width (b), and preferably 1.2 to 1.5-times greater than said width (b).

16. Wheel according to anyone of claims 1-14, characterized in that the number of spokes (3, 3′, 3″) corresponds to 5-15, preferably 6-12 and most preferably 8-10.
